(19) United States
(12) Patent Application Publication
(10) Pub. No.: US 2002/0138636 A1
(43) Pub. Date: Sep. 26, 2002

(54) Method for automatically mass generating personalized data report outputs

(76) Inventors: Mark Buttner, Middleton, WI (US); Andy Giesler, Madison, WI (US); Kiran Joshi, Madison, WI (US); Mark Lipsky, Waunakee, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/097,684

(22) Filed: Mar. 13, 2002

Related U.S. Application Data
(60) Provisional application No. 60/278,130, filed on Mar. 23, 2001.

(51) Int. Cl. G06F 15/16

(52) U.S. Cl. 709/229; 709/217

(57) ABSTRACT

A method of automatically generating and distributing personalized data reports via an electronic network comprising the steps of defining a set of report groups, creating a report template, and associating the report template with appropriate report groups of the set of report groups. The method also includes creating a security class and associating with the security class report groups of the set of report groups accessible to the security class. The method further includes providing the user with access to the report template based upon the security level, checking a user's security level and displaying the appropriate templates based on the check, creating a report output based on the report template, and providing the report output via the electronic network.

### CROSS-REFERENCE TO RELATED APPLICATIONS

This application claims priority to U.S. Provisional Application Serial No. 60/278,130, entitled “Method For Automatically Mass Generating Personalized Data Report Outputs,” filed Mar. 23, 2001 (Attorney Docket No. 29794/37189), the disclosure of which is hereby expressly incorporated herein by reference.

### FIELD OF THE INVENTION

The present invention relates generally to data report generation and distribution, and more specifically, the invention relates to a system for automatically mass generating data reports in a variety of personalized output formats and content sets determined by utilizing both the particular security needs of a large organization and the per user differences in enterprise role and personal preferences.

### BACKGROUND OF THE INVENTION

Large healthcare organizations operating software in a client-server environment often have need of providing production data to very large groups of users. In such an environment, the reporting needs of the organization vary greatly not only from one group of users to another, but also from one user to another. Furthermore, distributing the outputs to large groups of users once generated can create logistical problems with regard to immediate availability of, and consistent, appropriate access to the output files. Getting the right data from the right place and into the right person's hands as quickly as possible while still keeping other users from accessing the same data poses enough of a problem, to say nothing of allowing for personalized user preferences and outputs.

There are many factors involved in determining report outputs for users, such as what data each user needs to view based on what role he/she plays, what level of security is attached to the user when viewing sensitive data, and what preferences the user has about which reports to run and how the output is presented. It is problematic to mass generate a personalized report output for each member of a large group of users that takes into account all of these factors. For example, suppose that User A works in a hospital's billing office and needs to see the accounts receivable information for Department C, but suppose that User B is a scheduling supervisor in Department C and only needs to see the schedules for the providers in that department. Because of vastly different roles, the data each user requires is also very different.

Also, it is likely that different levels of security would be needed for people of similar roles. For example, while User A works in Department X's billing office and only needs to see financial information from that department, User C may be an organization's chief financial officer and needs to see information from all departments. Furthermore, if Department Y is a mental health department, it's possible that neither User A nor User B should see any data related to Department Y. Finally, User A might prefer to have reports output to a text file to be printed out and sent to patients while User B might prefer to see reports posted on an Intranet site to allow many other users to access the information.

Existing solutions to these problems typically include a couple of options. One option is for an organization to utilize a reporting Administrator who manually defines and schedules the reports that need to be run for the various groups of users. Another option might be to allow users to manually create their own report outputs. However, manual creation of reports is tedious when creating them for groups of users, and it is overwhelming when attempting to customize report outputs for each individual user. In addition, if users are creating their own outputs, it is hard to centrally manage the resources needed to run those reports.

Manual creation of reports also entails continued maintenance, thus perpetuating the challenge of personalized report outputs. Yet, allowing individuals to create their own reports may be cause for security and/or efficiency concerns, and is very often impractical due to the level of training required.

Also, there are many products available that can personalize content and organize data for individual users. However, these products fall short by either failing to mass generate the reports, failing to incorporate necessary security filters, or simply because they lack the ability to generate the reports at all.

When generating data reports that contain confidential information, it is imperative that some type of security is incorporated within the system to protect the unauthorized distribution or access of the data. One existing method of protecting the data is through the use of operating system security. For example, Microsoft Windows allows an administrator to set up security for both directories and individual files, indicating which users or groups of users have access to the directories and files. If all the files contained in a directory need to be similarly protected, it is a simple matter of setting permissions at the directory level and updating the permissions for the other files.

The disadvantage of applying Windows security is that if each file or directory needs to be individually protected and available only to the person for whom it was created, then every single directory or file output would need to be updated with the proper security. At best, the system would need to create a directory for every user and set the same level of permissions for every file contained in it. But then the system would need to generate each report for each individual user and could not use the same report output if two users requested the exact same report.

Another cumbersome technique used in the prior art is to build a database to designate the files and directories that each user is allowed to access. When a user wanted to access a file or directory, the application would run a code module that compared the requested file or directory with the user's (or group's) permissions and decide whether or not to show it to them. One obvious disadvantage of this method is that users must wait for a security check every time they ask the system for a report.

There is a demonstrated need for large organizations to be able to automatically mass generate data report outputs based on a user's security, role, and preferences. None of the previous systems satisfied this need.

### BRIEF DESCRIPTION OF THE DRAWINGS

FIG. 1 is a flowchart representation of the primary activities for a system that automatically generates personalized data reports in accordance with a preferred embodiment of the invention.

FIG. 2 is a flow chart representation of the primary activities used to define the report templates utilized to generate Report Outputs in accordance with a preferred embodiment of the invention.

FIG. 3 is a flow chart representation of a few of the activities used to ensure that each user has the proper security in accordance with a preferred embodiment of the invention.

FIG. 4 is a flow chart representation of the process involved in selecting a report in accordance with a preferred embodiment of the invention.

FIG. 5 is a flow chart representation of the process required to automatically ensure that each output file is secure in accordance with a preferred embodiment of the invention.

FIG. 6 is a flow chart representation of the actions required to generate Report Outputs based on Report Templates in accordance with a preferred embodiment of the invention.

FIG. 7 is a flowchart representation of a few of the main steps associated with generating a group of personalized data reports in accordance with a preferred embodiment of the invention.

### DETAILED DESCRIPTION OF THE PREFERRED EMBODIMENT

According to a preferred embodiment of the invention a system 10 is provided to automatically generate unique reports for individual users in an organization, based on predetermined criteria. Examples of such criteria include, but are not limited to: (1) the user's individual security level, (2) the report output types defined by the organization, and (3) the organization's output types a user prefers to see.

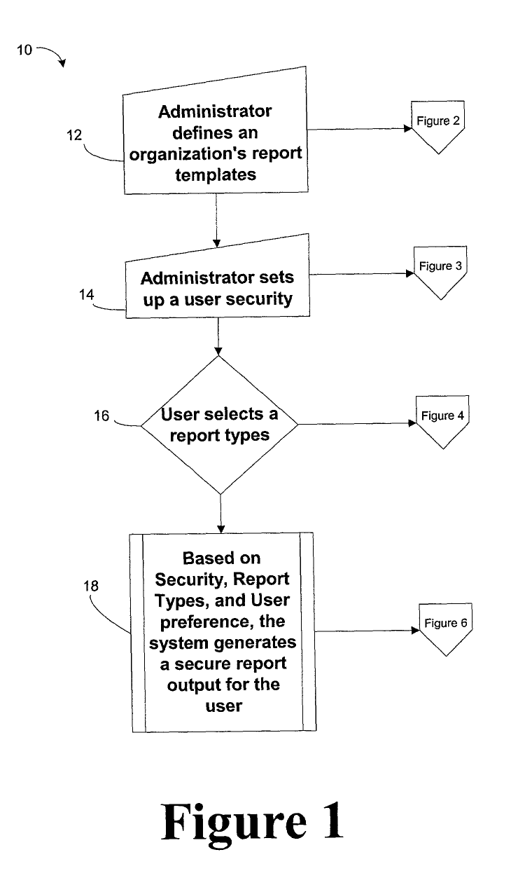

FIG. 1 is a flowchart representation of the primary steps utilized to allow the system 10 to automatically generate personalized data reports. There are three main factors involved in determining what data is included in the report output. First, at a step 12, a report administrator may define a report template for each report type that specifies what data to pull from a production data warehouse. This allows the organization to maintain control over the availability of reports since a user cannot select a report until it is made available. In a heavily security-dependant environment, this is common practice for many of the functions related to a user's role. Second, a security administrator at a block 14 ensures that every user is set up with a proper security level. A third factor is shown at a step 16, wherein a user selects at least one report type from the set of available report types. Once all the factors determining the report output have been set, at a block 18 the system iterates through all the users in the system and generates report outputs with appropriate data as determined by the user's security level and what report types they have selected. It should be noted that the system may be configured to generate only the reports selected by the users.

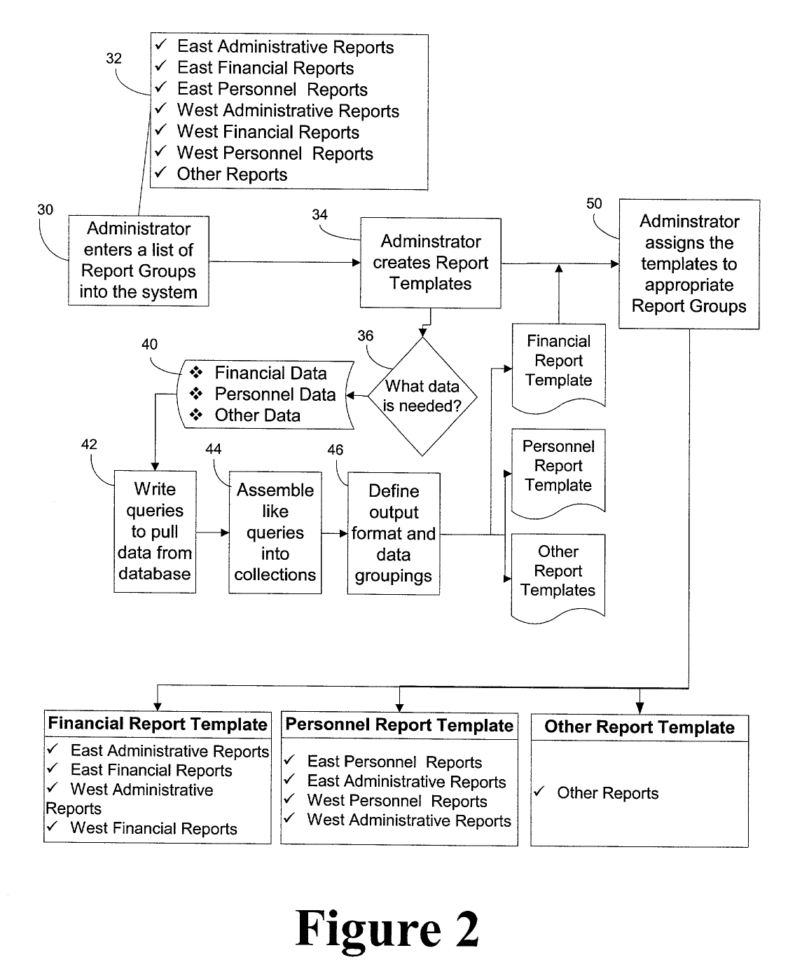

FIG. 2 is a schematic representation of a few of the activities used to define the report templates that are used to generate the Report Outputs. A first block 30 includes entering or defining a list of report groups, such as a block of Report Groups 32, into the system. The Report Groups 32 may be associated with both the Report Templates and with the Security Classes. Thus, a Report Group is a way to give many users access to many different reports at once. Which Report Groups an Administrator creates will depend on what reports will eventually be available and what data is being included in those reports. For example, one might want to create a group for Financial Reports (for use by Financial staff), a group for Personnel Reports (for use by Human Resources staff), a group for Administrative Reports (for use by administrators), or any other types of reports an organization might need.

At a block 34, the second action in defining a Report Template is to set up the parameters of the template itself. This may also include a number of actions, repeated for each template that is defined:

1. At a block 36, the person defining the template may decide what data needs to be included in the eventual output. For example, if the report will be a Financial Report, different data would be needed than if the report were to be a Personnel Report. A few examples of data types are shown at a block 40.

2. At a block 42, queries are written to pull the right production data from the warehouse or a database (e.g. Report Groups). For example, if the report is a Financial Report, it's likely that a query for Accounts Receivable information and a query for Accounts Payable information would be needed.

3. At a next block 44, the queries may be assembled into similar collections. For example, the queries for Accounts Receivable and Accounts Payable might be grouped together to appear in the same report.

4. Finally, at a block 46, the output type and special data groupings may be defined. For example, if the report is going to be made available to users via an intranet Web portal, the output type would be defined as HTML. Also, if any-sub groupings of the data are desired, those may be included as well. For example, if the user wants the financial data to be grouped by Date and/or Transaction Type.

At a block 50, an administrator may then associate the Report Templates with the appropriate Report Groups. For example, if a user created a Financial Template and a Personnel Template, each appropriate Report Group should be listed within the respective Report Templates.

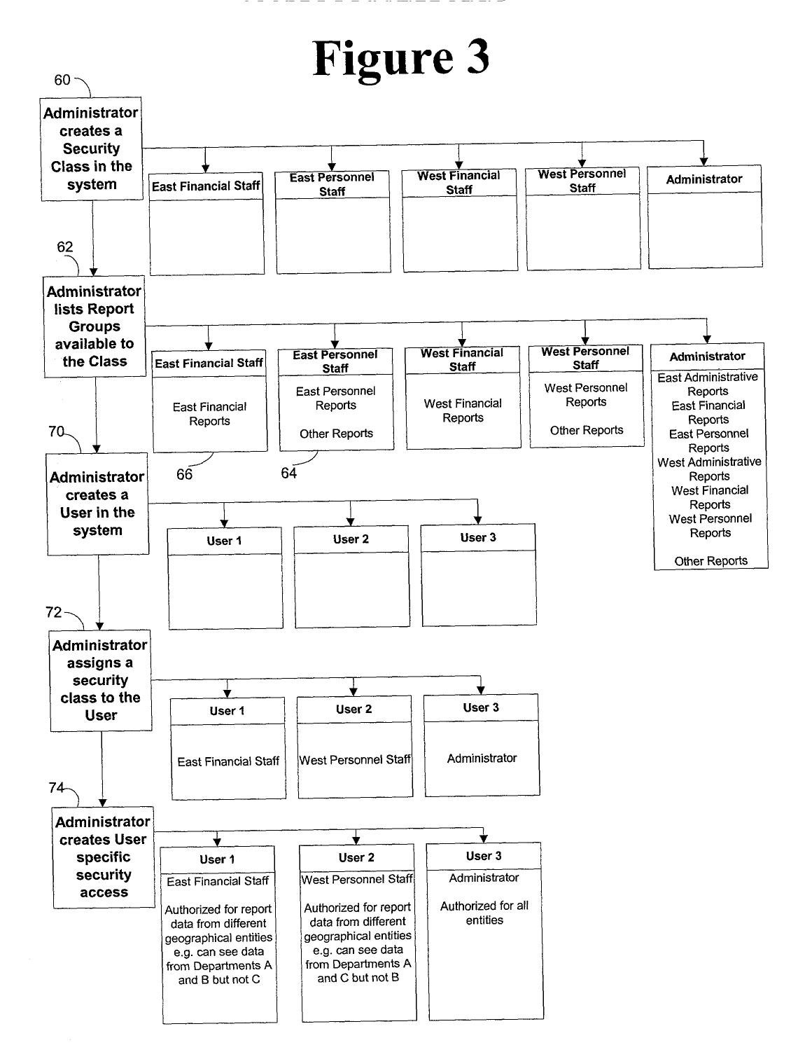

FIG. 3 is a schematic representation of a few activities initiated to ensure that each user has the proper security level. At a first block 60, an administrator may set up a Security Class in the system. A Security Class is simply a way to give many users the same security level in the system. For example, if an organization has an East Facility and a West facility, and users in one facility should not have like access to the same data from the other facility, separate security classes may be created to restrict access for users. Thus, Financial staff members in the East Facility might have their own class just as the Personnel staff members in the West Facility would have their own class.

At a second block 62 and within each Security Class, an administrator may list the available Report Groups associated with that class. (By listing Report Groups in Security Classes and then assigning each user a Security Class, multiple individual users can easily be linked to multiple individual Report Templates and still have report availability governed by the security level). For example, users with the East Personnel Staff security class 64 might be authorized for East Personnel Reports and other Miscellaneous Reports while users with the East Financial Staff security class 66 might only be authorized for the Financial Reports.

At a third block 70, an administrator may create a security record for each individual user in the organization (in heavily security-driven organization, this would likely be a necessary step for many other points of access as well as report data access).

Fourth, for each user, a particular level of security can be assigned by listing the appropriate Security Class, as shown at a block 72. Listing a Security Class links a user to the Report Groups specified in the class, and thus the Report Templates associated with that Report Group as well.

At a block 74, each user may be given even more specific security than what is specified in their Security Class. For example, even within the East Facility, perhaps User 1 should be able to see financial data from Departments A and B, but not from Department C. The data each user sees in their personal report can be controlled from within their own security rather than the security class. There could be many reasons for this, including the fact that Department C is a mental health department or that User 1 only works in Departments A & B and would have no need of seeing data from Department C.

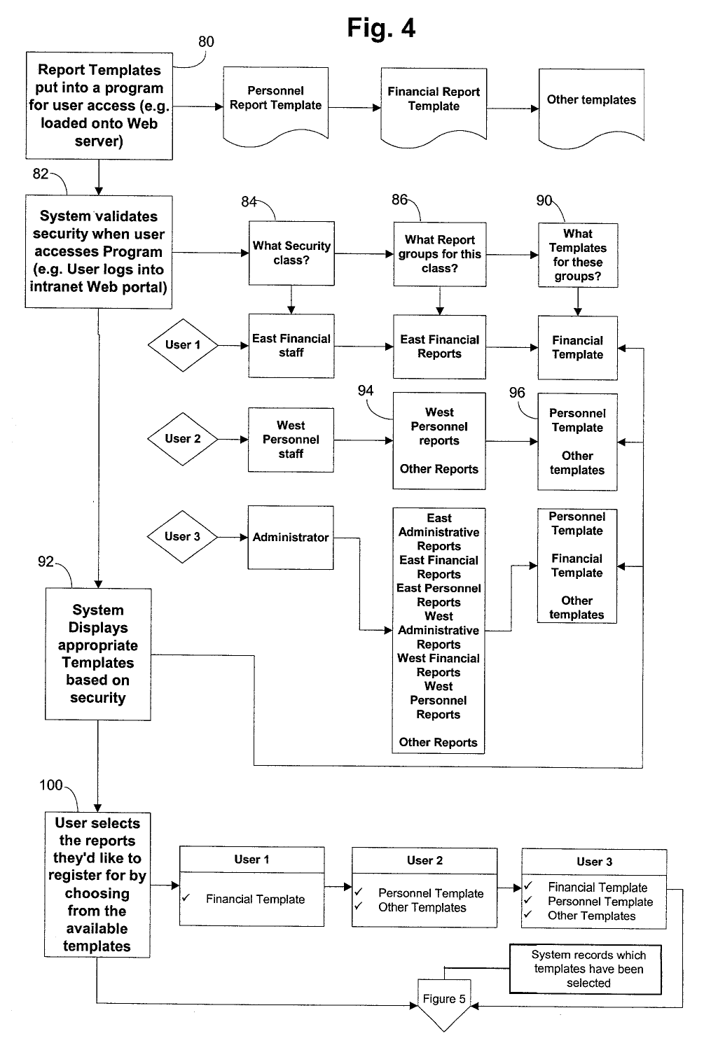

FIG. 4 is a schematic representation of the processes involved when a user selects a report. At a block 80, the Report Templates may be made available to a software program. For example, they might be loaded onto a server so they can be accessed through a Web portal.

At a block 82, the user may access the program (e.g. he might log into an intranet Web portal). When he does, the system may run a check to determine the security level he has. For example, at a block 84, the system may initially check to see what Security Class is assigned to the user. Then at a block 86, the system may check to see what Report Groups are associated with the Security Class. At a block 90, the system may check to see what Report Templates are associated with the Report Groups.

Based on all the security checks made in the block 82, the system knows what reports are available to the user and displays them in the program accordingly. This is shown at a block 92. For example, when User 2 logs into the program, the system checks his Security Class and finds that he is authorized for reports in both the West Personnel Report Group and the Other Reports Group, as shown at a block 94. The specific Report Templates available for these Report Groups are listed at a block 96 and include both the Personnel and the Other Templates. Thus, according to the diagram, there would be two templates displayed for User 2 to choose from.

At a block 100, the user may select the reports he wishes to see from among all those available to him. The system records which ones he has selected and makes them available to the user. For example, if using a Web portal as the program, the user would see a link to the Report Output when he logs into the portal. The system may be programmed so that only the reports selected by the user are generated, which may contribute to the overall efficiency of the system.

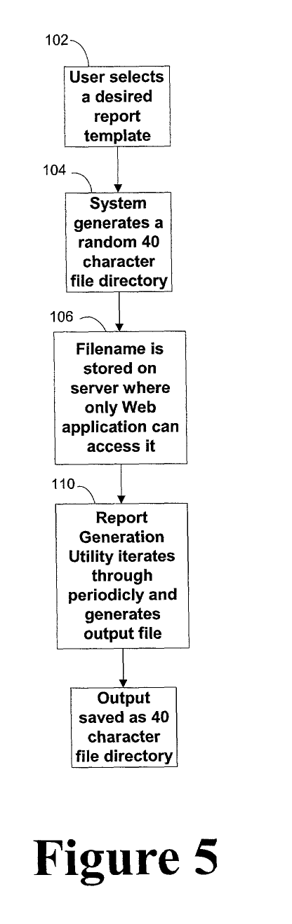

FIG. 5 is a schematic representation of the process involved in automatically ensuring that each individual output file is secure. While the Security Class and the User Security definitions govern and protect the data included in the reports, they do not protect access to the output file itself. For example, if a user was accessing his own report via a personal Web portal, the name of the file and it's location would be displayed in his browser. It is feasible for a user to speculate the naming conventions of the Report Outputs and access another user's report. In order to prevent this, a report administrator would need to set individual protections on each of the Report Output files stored on the server.

The following activities are included in the process of report generation in order to protect each file automatically. At a block 102, a user may select a report from all the reports available to him. This action causes the system to generate a lengthy string of random characters as the file path of the Report Output for the user at a block 104. The string of characters could be numeric only, alpha only, or alphanumeric, which is a combination of both, and may also include several additional characters. One possible technique to generate the random string of characters is to first generate a random number and then map that number into a range of ASCII characters. However, if a non-alphanumeric character is created, it is discarded and the steps are repeated until an acceptable character is generated. This process is repeated until a string of characters of the desired length is created. The string is 40 characters in this embodiment, but could easily be modified to comprise more or less characters.

The random file path that is generated could be a file directory, a filename, or any other acceptable alternative. In this embodiment, it is the file directory that is randomized. Randomizing the file directory prevents having to set the permissions for each directory. Additionally, it is highly improbable that the users could guess and type the directory names in the browser to see the list of files inside. It should also be noted that in this configuration, a random directory name is created for each report that is generated, and that directory contains just the one report, which has a non-random filename.

When a user requests a report, a random character string is generated. At a block 106, the random character string may be recorded in both the user's web page definition and in a lookup table that is maintained on the primary database server. However, the file itself is not generated until the report runs. In other words, the randomly generated file path is stored on the server, to be used later when the Utility iterates through every user and generates their report outputs. This is shown at a step 110.

This configuration ensures that the reports can only be accessed using the appropriate Web application. Thus, when a user logs into the secure Web application, a link to all the reports for which he is registered is displayed in the portal. The user is then able to click on the link and have the report displayed in his browser with all the appropriate data.

This technique is very secure and effective for several reasons. First, and as mentioned above, users can only get access to the reports through the web server. To get there though, users enter their ID and password to gain access to their personalized web page. Their personalized web page has a link to the otherwise unguessable filename. Therefore, possession of the link on a personal web page becomes the users security token to view the report.

In essence, this embodiment creates a virtual database of file-to-user mappings. The database here however, comprises a list of links on a usable web page. This provides the advantage of not having to write code to do the file-to-request confirmation. It is the browser that is essentially performing that function by offering the user only links for which they are authorized.

This embodiment does require the use of user-to-file mapping code, but the code runs much earlier, at the time when the decision is made as to what reports the users are permitted to sign up for. This is an enhancement in performance since the users do not have to wait for a security check, however briefly, every time that they ask the system for the file. This is because they already completed and passed the security check earlier when they signed up for the report.

Because the file path is such a large, random alphanumeric, it is extremely unlikely that anyone would ever access the file improperly. Thus, the name of the file path itself becomes the security protection when the output file is stored on the server. Also, once stored on the Web server, the files can only be accessed via the Web application. Also, directory browsing may be turned off, so that users would need to know the exact filename in order to access the file.

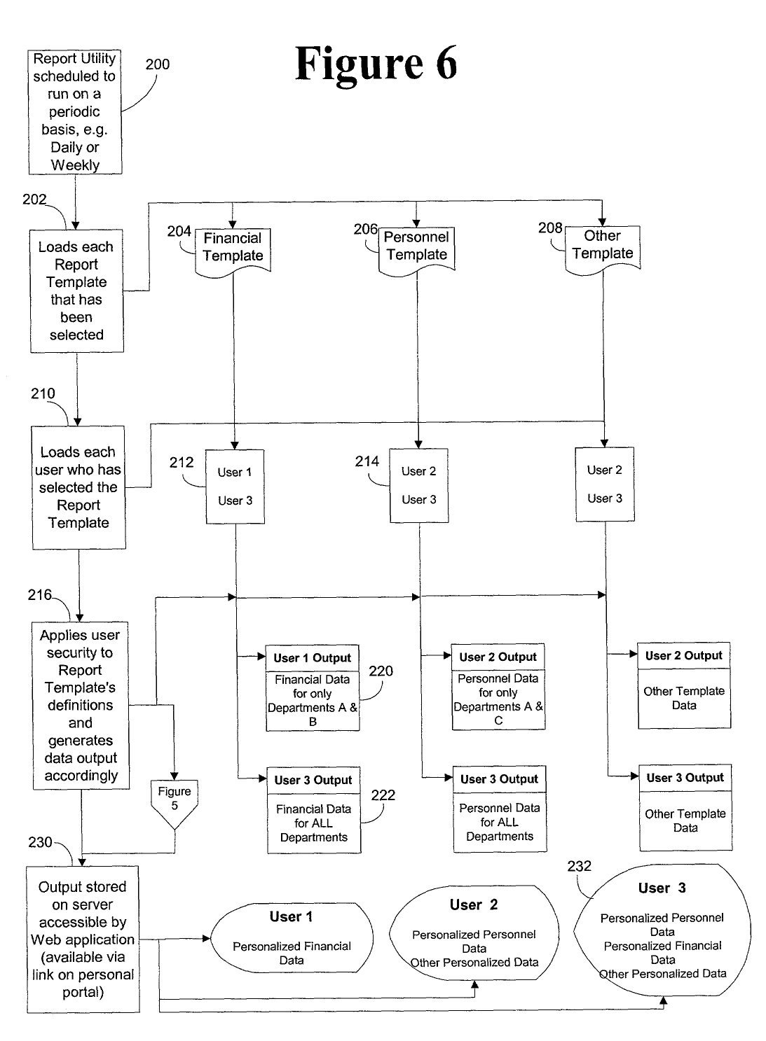

FIG. 6 is a schematic representation of a few of the processes involved in actually generating the Report Outputs based on the Report Templates. At a block 200, a report Administrator schedules a Utility to run on a network on a periodic basis, e.g. monthly, weekly, or daily.

At a block 202, the utility may load every Report Template that has been selected by any user every time the utility runs. For example, since each of the Report Templates 204, 206, and 208 in the diagram has been selected by at least one user, each template 204, 206, and 208 would be loaded by the Utility.

At a block 210, the Utility may load the user record for every user that has selected the Report Template. For example, when it loads the Financial Template 204, the Utility may load the user records for both User 1 and User 3 as seen in block 212, but when it loads the Personnel Template 206, it may load User 2 and User 3, as shown in block 214.

The Utility creates the required Report Output type as shown at a block 216. When the Utility loads each user record, it applies the security settings specific to that user and filters the data accordingly. For example, when it loads the record for User 1, the output format at a block 220 only contains financial data for Departments A and B, but when it loads the record for User 3, the output format at a block 222 includes financial data for all departments (since User 3 is an administrator). Thus, only those reports previously selected by users are run by the Utility. Also, if reports had previously been requested and generated, the next generation of the report would merely write over the old report. In other words, only one report is stored on the server for a user, and the report is updated with new data in subsequent runs.

Lastly, at a block 230, the personalized Report Outputs for the Report Templates each user selected are made available to each user when he or she logs into the program. For example, at a block 232, in a Web portal, User 3 (the administrative user) would see hyperlinks to personalized Personnel data, personalized Financial data, and any other personalized Report Template he selected.

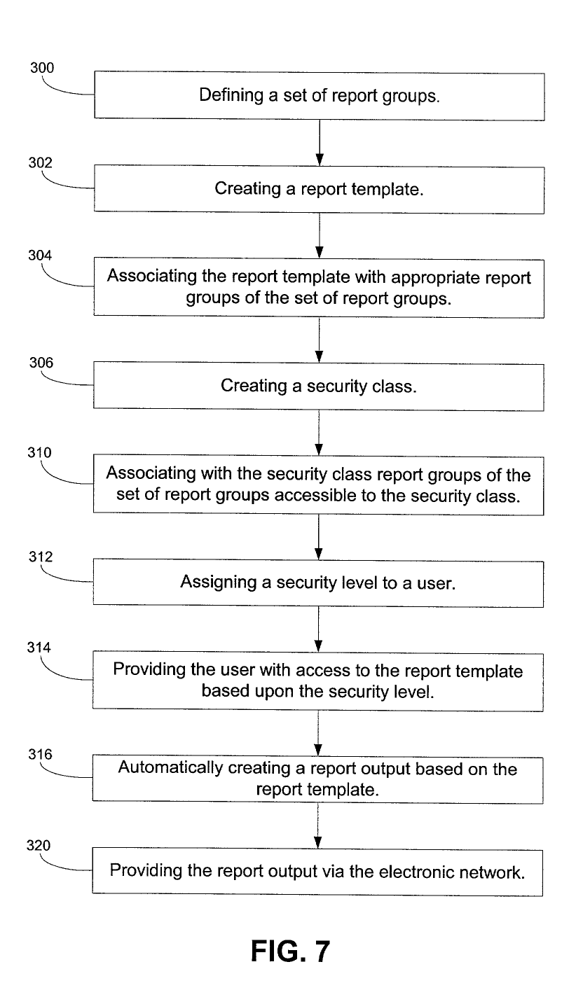

FIG. 7 is a flowchart representation of a few of the main steps associated with generating a group of personalized data reports. A first step 300 includes defining a set of report groups and a next step 302 includes creating a report template. A step 304 involves associating the report template with appropriate report groups of the set of report groups. This assumes that a plurality of report groups have been defined, however it is not necessary. Once the templates have been assigned to the appropriate report groups, a next step 306 is to create a security class and thereafter at a step 310 report groups of the set of report groups accessible to the security class are associated with the security class.

At a step 312, each user is assigned a security level. A next step 314 includes providing the user with access to the report template based upon the security level. Then at a step 316, a report output is created based on the report template and at a step 320 the report output is provided to the user via the electronic network. A utility program may be scheduled to run on a periodic basis to automatically load all of the report templates that were selected for all of the users.

Although the technique for automatically generating data report outputs described herein is preferably implemented in software, it may be implemented in hardware, firmware, etc., and may be implemented by any other processor associated with the organization. Thus, the routines described herein may be implemented in a standard multi-purpose CPU or on specifically designed hardware or firmware as desired. When implemented in software, the software routine may be stored in any computer readable memory such as on a magnetic disk, a laser disk, or other storage medium, in a RAM or ROM of a computer or processor, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

The invention has been described in terms of several preferred embodiments. It will be appreciated that the invention may otherwise be embodied without departing from the fair scope of the invention defined by the following claims.

We claim:

1. A method of automatically generating and distributing personalized data reports via an electronic network comprising the steps of:
defining a set of report groups;
creating a report template;
associating the report template with appropriate report groups of the set of report groups;
creating a security class;
associating with the security class report groups of the set of report groups accessible to the security class;
assigning a security level to a user;
providing the user with access to the report template based upon the security level;
creating a report output based on the report template; and
providing the report output via the electronic network.

2. The method of claim 1, wherein the step of creating the report template comprises setting up a group of parameters for the report template.

3. The method of claim 1, wherein the step of creating the report template comprises writing queries to pull data from a database.

4. The method of claim 1, further comprising the step of scheduling a utility program to run on a periodic basis to automatically load the report template for all users that selected the report template.

5. The method of claim 1, wherein the step of providing the user with access to the report template based upon the security level includes displaying the report template.

6. The method of claim 1, further comprising the step of allowing the user to select a report template for periodic review.

7. A method of automatically generating and distributing personalized data reports via an electronic network comprising the steps of:
defining a set of report groups;
creating a report template;
associating the report template with appropriate report groups of the set of report groups;
creating a security class;
associating with the security class report groups of the set of report groups accessible to the security class;
assigning a security level to a user;
scheduling a utility program to run on a periodic basis to automatically load the report template;
creating a report output based on the report template; and
providing the report output via the electronic network.

8. The method of claim 7, wherein the step of creating the report template comprises setting up a group of parameters for the report template.

9. The method of claim 7, wherein the step of creating the report template comprises writing queries to pull data from the report groups.

10. The method of claim 7, further comprising the step of providing the user with access to the report template based upon the security level.

11. The method of claim 10, wherein the step of providing the user with access to the report template based upon the security level includes displaying the report template.

12. The method of claim 7, further comprising the step of allowing the user to select a report template for periodic review.

13. A method of automatically generating and distributing personalized data reports via an electronic network comprising the steps of:
defining a set of report groups;
creating a plurality of report templates;
associating each report template with appropriate report groups of the set of report groups;
creating a security class;
associating with the security class report groups of the set of report groups accessible to the security class;
assigning a security level to a user;
displaying report templates accessible by the user based upon the security level;
allowing the user to select a report template for periodic review;
scheduling a utility program to run on a periodic basis to automatically load the report template;
creating a report output based on the report template; and
providing the report output to the all users that selected the report template via the electronic network.

14. The method of claim 13, wherein the step of creating the report template comprises setting up a group of parameters for the report template.

15. The method of claim 13, wherein the step of creating the report template comprises writing queries to pull data from the report groups.

16. The method of claim 13, further comprising the step of providing the user with access to the report template based upon the security level.

17. A method of automatically generating and distributing personalized data reports via an electronic network comprising the steps of:
entering a report group;
creating a report template;
associating the report template with the report group;
creating a security class;
associating the report group with the security class;
assigning a security level to a user;
providing the user with access to the report template based upon the security level;
creating a report output based on the report template; and
providing the report output via the electronic network.

18. A system for automatically generating and distributing personalized data reports for an organization having a processor, via an electronic network, the system comprising:
a memory;
a first software routine stored in the memory and adapted to be executed on the processor to execute the step of checking a user's security level and displaying an appropriate template based on the check;
a second software routine stored in the memory and adapted to be executed on the processor to execute the step of enabling the user to select a report template from a plurality of report templates to review;
a third software routine stored in the memory and adapted to be executed on the processor to execute the step of automatically loading the selected report template;
a fourth software routine stored in the memory and adapted to be executed on the processor to execute the step of creating a report output based on the selected report template; and
a fifth software routine stored in the memory and adapted to be executed on the processor to execute the step of providing the report output via the electronic network to all users that selected the report template.

19. The system of claim 18 wherein the first software routine checks the user's security level by checking the user's security class.
